(19) United States
(12) Patent Application Publication
(10) Pub. No.: US 2017/0126093 A1
(43) Pub. Date: May 4, 2017

(54) ELECTRIC MOTOR WITH CARRIER MEANS

(71) Applicant: Robert Bosch GmbH, Stuttgart (DE)

(72) Inventor: Harold Bitzer, Buehl (DE)

(21) Appl. No.: 15/318,003

(22) PCT Filed: Apr. 22, 2015
(86) PCT No.: PCT/EP2015/058629

§ 371 Date: Dec. 12, 2016

(30) Foreign Application Priority Data
Jun. 11, 2014 (DE) 10 2014 211 109.9

(51) Int. Cl. H02K 5/26; H02K 1/14; H02K 11/30; H02K 5/16; H02K 7/14; H02K 1/18; H02K 3/18

(52) U.S. Cl. CPC H02K 5/26; H02K 1/187; H02K 1/146; H02K 3/18; H02K 5/161; H02K 7/14; H02K 11/30; B60L 1/003

(57) ABSTRACT

The invention relates to an electric motor (1), in particular for a motor vehicle fan, comprising rotor guide means (25) and a housing element (10). According to the invention, said housing element (10) is designed as a deep-drawn body part and carrier means (40) are provided for maintaining the rotor guide means (25). Said carrier means (40) are arranged on the housing element (10), in particular connected thereto, preferably secured thereon, and are designed as, in particular as a sintered part.

### BACKGROUND OF THE INVENTION

The invention relates to an electric motor.

Electric motors comprising rotor guide means and housing elements are already known. It is also known that the housing elements are produced by means of diecasting, in particular zinc, aluminum or magnesium diecasting. Diecasting is used to produce housing elements that have sufficient stability. Housing elements formed by diecasting, however, are heavy and expensive.

### SUMMARY OF THE INVENTION

The electric motor according to the invention has the advantage of a simplified and thus economical production of the electric motor. A further advantage is considered to be the fact that, due to the use of a bent sheet metal part, in particular a deep-drawn sheet metal as housing element, less material is required compared to the diecast housing element, and therefore the weight of the housing element and of the electric motor can be reduced. Furthermore, the production of a bent sheet metal part is less complex and thus more convenient compared to the production of a cast part.

It is particularly advantageous that the carrier means has a first recess, which in particular is continuous. Furthermore, the rotor guide means is mounted in the first recess in the carrier means in a rotationally fixed or rotatable manner. By accommodating the rotor guide means in a recess in the carrier means, the stability of the electric motor can be increased. It is also advantageous that the assembly and thus the production of the electric motor can be simplified.

An advantageous development is characterized in that the rotor guide means and the carrier means are connected, in particular in a form-locked and/or force-locked manner. Due to the force-locked and/or form-locked connection of the carrier means to the rotor guide means, a rotationally fixed connection between the carrier means and the rotor guide means is achieved. A rotationally fixed connection of the carrier means to the rotor guide means is advantageous for certain electric motor mountings, in particular external rotor motors. In order to increase the stability, it is also advantageous for the rotor guide means to be press fitted or cast in into the first recess in the carrier.

An advantageous development is that the carrier means has a bearing element. In particular, the bearing element is arranged in the first recess in the carrier means. The bearing element guides, in particular supports, the rotor guide means rotatably relative to the carrier means. The rotatable mounting of the rotor guide means relative to the carrier means is advantageous for electric motors which have an internal rotor in relation to the stator.

A development of the invention is that the electric motor has a stator. The stator is in particular connected to the carrier means in a form-locked and/or force-locked manner. Due to the form-locked and/or force-locked connection between the stator and the carrier means, forces or torques that occur between the rotor and the stator during operation or standstill can be optimally transferred.

It is particularly advantageous that the carrier means has an orientation means which orientates, in particular centers, the stator relative to the rotor guide means. The assembly of the individual elements of the motor is simplified by the orientation means on the carrier means, which results in an accelerated production of the electric motor. The carrier means can advantageously have an orientation means which implements an orientation relative to the housing element.

An advantageous development of the invention is that the electric motor has a connection means, wherein the connection means connects the carrier means to the housing element and/or a stator in a form-locked and/or force-locked manner. Connection of the carrier means to the housing element and/or the stator is possible in a simple manner by the connection means.

It is also advantageous that the connection means is formed as a screw, in particular as a self-tapping screw. It is also advantageous that the carrier means has a second recess, which in particular is continuous, wherein the connection means and the second recess cooperate, the connection means in particular engaging in the second recess. The stability of the electric motor is improved by the cooperation of the second recess in the carrier means with the connection means.

An advantageous development is that the housing element has a recess, wherein the recess cooperates with the connection means. The stability of the electric motor is improved by the cooperation of the recess in the housing element with the connection means. Elements of the electric motor can also be connected to the housing element. It is advantageous in particular when the recess is formed as a passage in the sheet metal of the housing element. The design of the recess as a passage enables a simple production of a recess that enables the best possible, in particular stable connection between the housing element and the connection means.

It is advantageous that the carrier means has at least one spoke. It is also advantageous when the carrier means has a middle element, wherein the middle element has a first recess. The spoke is arranged on the middle element. The at least one spoke, together with the middle element, increases the stability of the carrier means. Forces or torques created at standstill or during operation can be optimally absorbed or emitted by the carrier means.

It is particularly advantageous that the spoke has a second recess, which in particular is continuous, for connection of the carrier means to the housing element and/or the stator. The second recess cooperates with a connection means, in particular a screw, preferably a self-tapping screw. The arrangement of a second recess in the spoke and the cooperation of the second recess with a connection means enables an optimal absorption and emission of forces or torques into or from the connection means.

A preferred development of the invention is that the electric motor has control electronics, and the control electronics are arranged on the housing element, in particular the housing element is part of the housing of the control electronics.

### BRIEF DESCRIPTION OF THE DRAWINGS

Exemplary embodiments of the invention are illustrated in the drawings and will be explained in greater detail in the following description. In the drawings:

FIG. 1 shows a sectional view through an electric motor 1,

FIG. 2 shows a housing element formed by means of diecasting,

FIG. 3 shows a perspective view of a housing element according to the invention formed from a deep-drawn sheet metal part,

FIG. 4 shows a perspective view of a carrier means according to the invention,

FIG. 5 shows an electric motor with a housing element, a carrier means, a stator, and a rotationally fixed rotor guide means,

FIG. 6 shows an electric motor with a housing element, a carrier means, a stator, and a rotationally fixed rotor guide means in the assembled state,

FIG. 7 shows an electric motor with a housing element, a carrier means, a stator, and a rotatably mounted rotor guide means,

FIG. 8 shows an electric motor with a housing element, a carrier means, a stator, and a rotatably mounted rotor guide means in the assembled state,

FIG. 9 shows a further exemplary embodiment with a bearing element in the stator, and

FIG. 10 shows the further exemplary embodiment in the assembled state.

### DETAILED DESCRIPTION

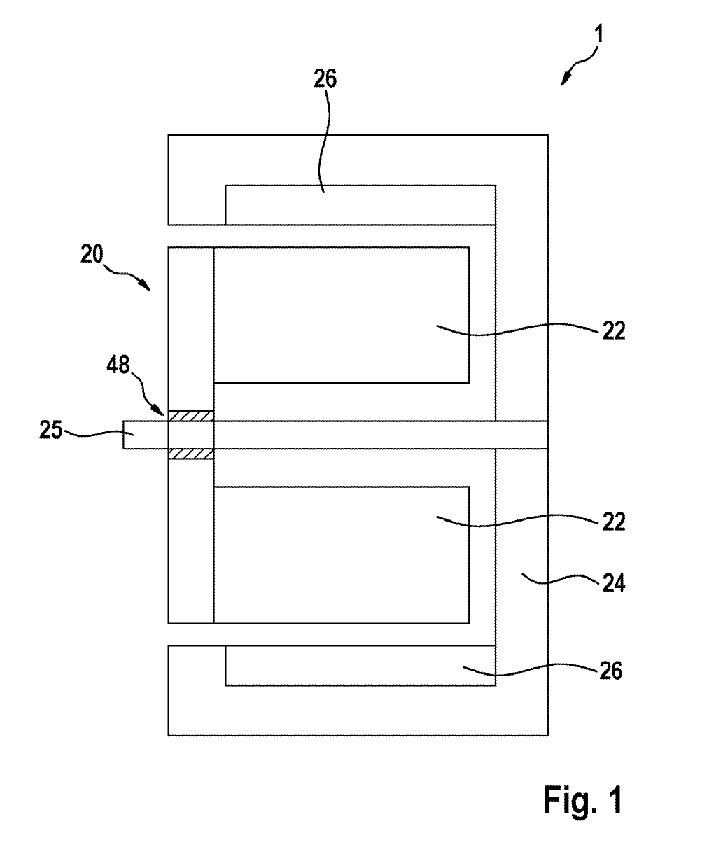

FIG. 1 shows a sectional view through an electric motor 1, in particular an external rotor electric motor. The electric motor 1 comprises a stator 20 with stator coils 22, and comprises a rotor 24 and a rotor guide means 25. The rotor guide means 25 guides the rotor 24, wherein the rotor 24 is arranged rotatably relative to the stator 20. The rotor guide means is mounted rotatably relative to the stator 20 by the bearing element 48. The rotor 24 comprises magnets 26.

Electronically commutated electric motors belong to the group of synchronous DC motors, that is to say an electromagnetic rotary field generated by stator coils 22 has the same rotational speed as a rotor 24. In order to generate a rotational movement, the stator coils 22 must be energized in a specific sequence. The generated magnetic field in the stator coils 22 leads to an attraction or repulsion of the magnets 26 of the rotor 24 and therefore to a rotation of the rotor 24. This sequence is generated by electronics, in particular control electronics.

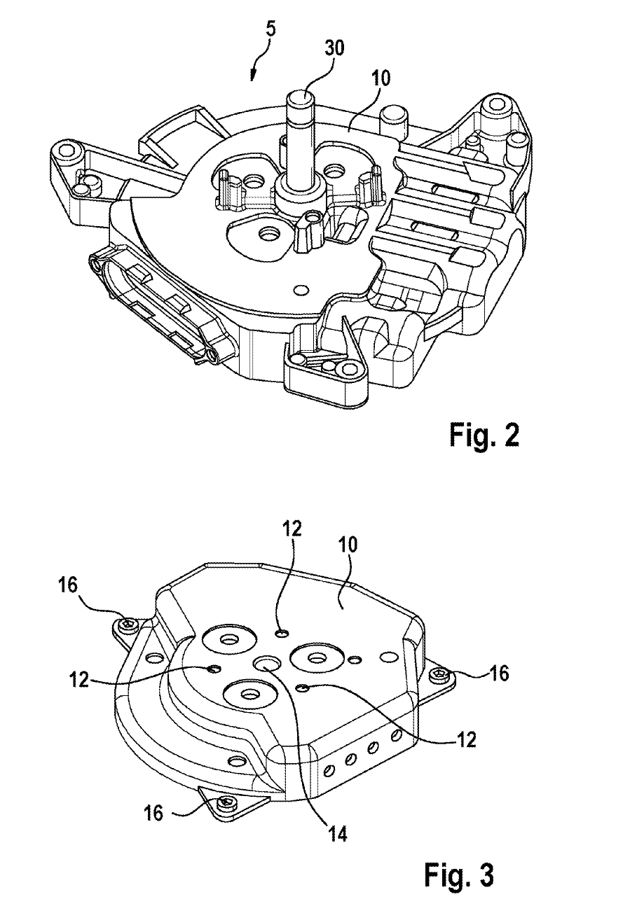

The electronics are arranged on a housing element 10 (see FIGS. 2-10) or in a housing 5 for protection against or dissipation of heat. It is advantageous when the electronics are arranged as close as possible to the stator coils 22 in order to keep line elements between the electronics and the stator coils 22 as short as possible. The radiation of electromagnetic emission can also be reduced by the arrangement of the electronics close to the stator coils.

The rotor 24 is arranged rotatably relative to the stator 20 via the rotor guide means 25. During operation or at standstill, forces and torques act between the rotor 24 and the stator 20. These forces and torques also act on devices or elements connected to the electric motor 1. If the stator 20 is mounted in particular on a housing element 10, the forces and torques will be transferred thereto. Conversely, forces and torques are transferred from the housing element 10 to the stator 20 and/or the rotor 24. For this reason, the rotor 24, the stator 20, and further elements of the electric motor 1 must have sufficient stability to be able to absorb and/or transfer the forces or torques occurring at standstill or during operation.

By way of example, the housing element 10 is part of a housing 5, in particular a casing, a transmission, electronics, or a fan housing. The housing element 10 serves in particular to secure the electric motor 1 to a casing, a transmission, electronics, or a fan housing. Forces or torques from outside the electric motor 1 act on the housing element 10. The housing element 10 also transfers forces which for example act on the rotor 24 to the surrounding environment, in particular a casing, a transmission, or a fan housing.

The purpose of the housing element 10 is, amongst other things and besides the heat dissipation and protection of the electronics, the rotor 24, or the stator 20, to also transfer forces that act on the electric motor 1 from outside the electric motor 1, and vice versa.

In the prior art, housing elements 10 produced from diecast aluminum are used in accordance with FIG. 2. The housing elements 10 at the same time form a sort of motor flange for the electric motor 1. The housing element 10 according to the prior art has a complex geometry for optimal force absorption and distribution. The housing elements 10 also have further geometries, such as securing holes for securing electronics, the stator and/or the housing in fan casings. With aluminum diecast parts, complex geometries that can absorb high forces and torques can be provided. For this reason, housing elements 10 in the prior art are realized as aluminum diecast parts.

FIG. 2 shows a diecast housing element 10 according to the prior art. The shaft 30 of the electric motor 1 is fixedly connected to the housing element 10. The shaft 30 is connected to the housing element 10 in a form-locked and force-locked manner. The shaft 30 is in particular molded into the housing element 10. The housing element 10 according to FIG. 1 is thus formed in one part. In particular, a disadvantage of a housing element 10 produced by means of diecasting is constituted by the short die service lives of a diecasting die as well as the necessary and complex/costly deburring and cleaning processes of an aluminum diecast part, i.e. the housing element 10, which are absolutely necessary for the installation of the electronics and for implementation of a liquid-tight concept. In addition, the placement of the shaft 30 in the diecasting die increases the cycle time. In addition, the packing volume of the housing element 10 is adversely affected by the injected shaft 30. This spatial requirement leads to increased transport costs.

FIG. 3 shows a housing element 10 according to the invention. The housing element 10 is formed as a deep-drawn sheet metal part, in particular as a deep-drawn sheet metal part made of aluminum. The housing element 10 according to the invention is produced from a sheet metal by means of deep drawing. The housing element 10 is part of a housing 5. In particular, housing elements 10, in particular two such housing elements, form a housing 5 for the stator 20 and the rotor 24 of the electric motor 1 or a housing 5 for electronics, which control the electric motor. The electronics and the stator 20 are advantageously arranged on the housing element 10, in particular are connected thereto, and preferably secured thereto. The housing element 10 thus also serves as a connector of the individual elements, such as the rotor 24, stator 20, and rotor guide means 25 of the electric motor 1.

The housing element 10 has at least one recess 12, in particular a passage or a bore. The recess 12 cooperates with a connection means 50 (see FIG. 5). The connection means 50 serve to connect, in particular to mount the elements of the stator 20 on the housing element 10, and vice versa. By way of example, the housing element 10 in FIG. 3 has three recesses 12.

In accordance with one embodiment, the housing element 10 according to FIG. 3 has a rotor guide means recess 14. The rotor guide means 25 can be partially arranged in the rotor guide means recess 14 or guided thereby. The screw heads in the openings 16 serve to secure a further housing element 11 to the housing element 10 or to mount the housing element 10 on an external element, in particular a casing, a transmission, or a fan housing.

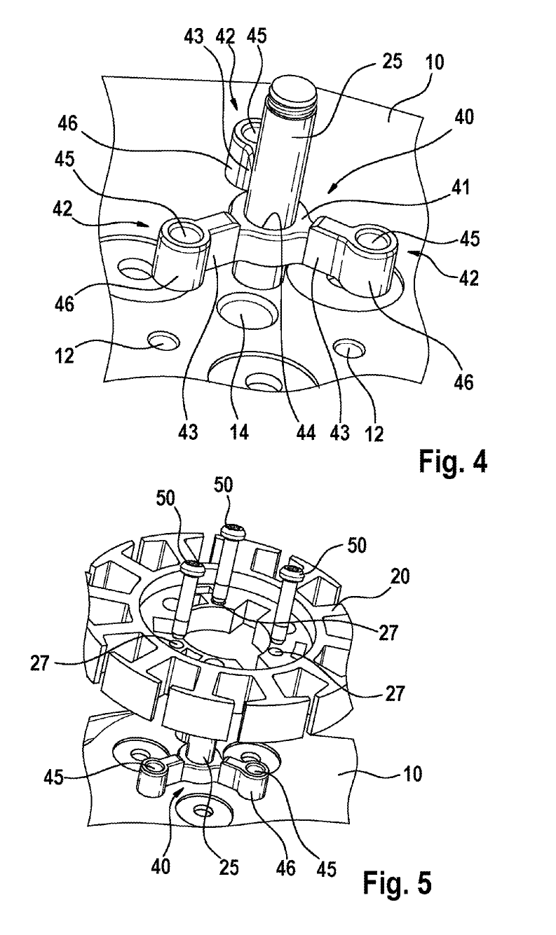

FIG. 4 shows a carrier means 40 according to the invention. The carrier means 40 is produced in particular as a sintered part. The carrier means 40 according to FIG. 4 has three spokes 42 by way of example. In accordance with the invention, the carrier means 40 can have an arbitrary number of spokes 42, in particular one, two, four, five or six. The carrier means 40 also comprises a middle element 41. The spokes 42 are arranged around the middle element 41 in a star-shaped manner. The spokes 42 extend radially outwardly here. The spokes 42 and the middle element 41 are formed in one piece. The carrier means 40 comprises a first recess 44. A rotor guide means 25 is arranged in the first recess 44. The rotor guide means 25 can be connected to the carrier means 40 in a rotationally fixed or rotatable manner. A rotor guide means 25 connected in a rotationally fixed manner is referred to as a spindle, and a rotor guide means 25 arranged rotatably is referred to as a shaft.

It is particularly advantageous that the carrier means 40, which in particular is formed as a sintered part, has a coefficient of expansion substantially identical to that of a rotor guide means 25 made of steel.

In accordance with the exemplary embodiment in FIG. 4, the rotor guide means 25 passes through the carrier means 40. The rotor guide means 25 protrudes in the assembled state into the rotor guide means recess 14 in the housing element 10.

The spokes enable an improved distribution of the force over the housing element 10, and vice versa. The spokes 42 have a length dependent on the torque and the force. The spokes 42 each have a second recess 45. The second recess 45 is arranged at the end of the corresponding spoke 42 averted from the rotor guide means 25. The spokes 42 also have a spoke head 46. The spoke head 46 comprises the second recess 45. The spoke head 46 is connected to the middle element 41 via a spoke rib 43. The spoke heads 46, the spoke ribs 43, and the middle element 41 of the carrier means 40 are formed in one piece.

The spokes 42 are advantageously arranged at a uniform angle to one another. By way of example, in the case of a carrier means 40 having three spokes 42, the spokes 42 are arranged at an angle of 120 degrees to one another. In the case of a carrier means 40 having four spokes 42, the spokes 42 are arranged at an angle of 90 degrees to one another. By means of a uniform arrangement of the spokes 42, forces that act on the housing element 10 via the rotor guide means 25 and vice versa can be distributed in the best possible way.

FIG. 5 shows a stator 20, a rotor guide means 25, a carrier means 40, a housing element 10, and a connection means 50 of an electric motor 1 according to the invention. The carrier means 40 and the housing element 10 are formed in a manner corresponding to the carrier means 40 from FIG. 4. The stator 20 has recesses 27, in particular continuous recesses 27, preferably continuous bores. The recesses 27 in the stator 20 are arranged in line with the second recesses 45 in the carrier means 40 and the recesses 12 in the housing element 10. A connection means 50 is inserted, in particular screwed, into the recesses 27 in the stator 20, the second recesses 45 in the carrier means 40, and the recess 12 in the housing element 10.

The connection means 50 is formed in particular as a screw with a thread, advantageously as a self-tapping screw. Self-tapping screws or thread-forming screws are connection means 50 which, when screwed into a core hole, produce their female thread themselves by chipless shaping. The connection means 50 provides a form fit and/or a force fit between the stator 20, the carrier means 40, and the housing element 10.

In accordance with the invention, the connection means 50 can provide a form fit and/or force fit between the carrier means 40 and the housing element 10.

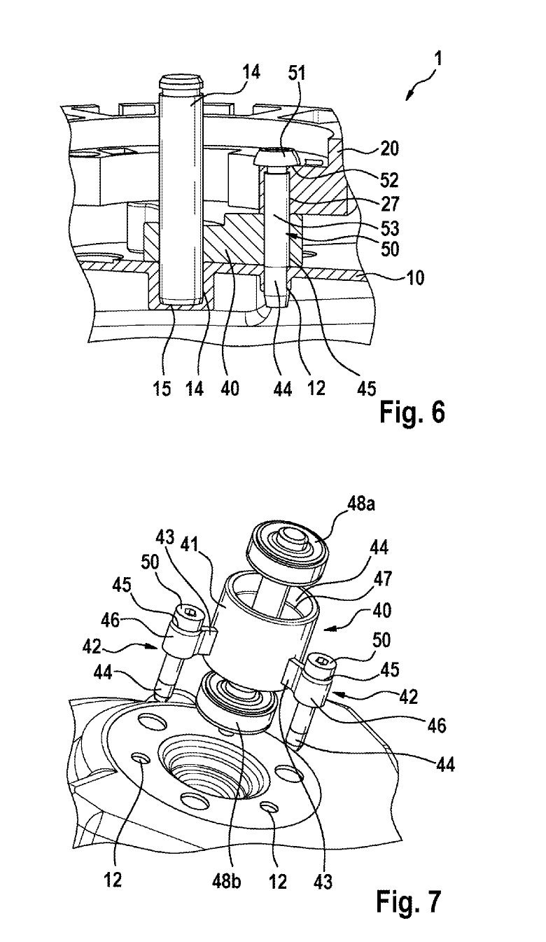

FIG. 6 shows an exemplary embodiment of an electric motor 1 according to the invention in a partly assembled state. The stator 20, the carrier means 40, and the housing element 10 are connected to one another by means of a connection means 50. The connection means 50 is formed in particular as a self-tapping screw. The connection means 50 comprises a screw head 51. An annular contact face 52, which in the illustrated exemplary embodiment bears against the stator 20, is disposed on the underside of the screw head 51. The contact face 52 is adjoined by a screw shank 53 having a thread 44, which in particular is a self-tapping thread. The screw shank 53 engages in the recess 27 in the stator 20 and in the recess 45 in the carrier means 40. The connection means 50 is fixed in the recess 12 of the housing element 10 via the produced female thread. The recess 27 in the stator 20 and the recess 45 in the carrier means 40 are advantageously minimally larger than the screw shank 53. The recess 12 in the housing element 10 is smaller than the self-tapping thread 44 of the self-tapping screw 50.

In accordance with a further embodiment the recess 12 in the housing element 10 has a thread, and the connection element 50 has a thread corresponding to the thread of the housing element 10.

In accordance with one embodiment the recess 12 of the housing element 10 is formed as a passage.

FIG. 6 shows a housing element 10 with a rotor guide means recess 14 by way of example. A rotor guide means recess 14 in the housing element 10 is necessary when the rotor guide means 25 passes through the carrier means 25. The rotor guide means 14 is arranged in the rotor guide means recess 14. The rotor guide means recess 14 is deep-drawn and has a rotor guide means recess base 15. The rotor guide means 14 bears against the rotor guide means recess base 15.

FIG. 7 illustrates a further embodiment according to the invention. The carrier means 40 comprises, by way of example, a middle element 41 on which three spokes 42 are arranged. The middle element 41 and the spokes 42 are formed in one piece. The carrier element 40 is advantageously formed as a sintered part. The spokes 42 have second recesses 45 at their ends averted from the middle element 41. In particular, connection means 50 for mounting, in particular securing the carrier means 40 on the housing element 10 can be arranged in the recesses 45. Furthermore, the spokes 42 have an annular surround 46 of the second recesses 45. The angular surrounds 46 are connected to the middle element 41 via a spoke rib 43. The angular surrounds, together with second recesses 45, form a spoke head 46. The annular surround of the second recesses 45, the spoke ribs 43, and the middle element 41 are formed in one piece. The carrier means 40 can have an arbitrary number of spokes 42 in accordance with the invention. The arrangement of the spokes 42 is dependent on the number of spokes 42.

In accordance with FIG. 7 the spokes 42 are arranged in particular uniformly relative to one another. By way of example, in the case of three spokes 42, the three spokes 42 are arranged at an angle of 120 degrees to one another.

The carrier means 40 comprises a first recess 44. One or more bearing elements 48 can be arranged in the first recess 44. In accordance with FIG. 7 a first bearing element 48a and a second bearing element 48b are arranged in the recess. The first and the second bearing element 48a and 48b support the rotor guide means 25 rotatably relative to the carrier means 40. The bearing element 48a/48b is formed in particular as a ball bearing or plain bearing. The bearing elements 48a and 48b are each arranged in the first recess 44 of the carrier means 40. The bearing element 48a is arranged in the longitudinal direction at an end, in particular the upper end, of the carrier means 40. The bearing element 48b is arranged in the longitudinal direction at the end of the carrier means 40 opposite the upper end, in particular at the lower end. The inner diameter of the first recess 44 corresponds in the region of the arranged bearing elements 48a and 48b to the outer diameter of the bearing elements 48a and 48b. A stop in the recess 47 prevents a shifting of the bearing element 48a in the carrier means 40. A corresponding stop for the second bearing element 48b is not shown in the drawing.

The carrier element 40 is connected to the housing element 10 via the connection means 50. The carrier means 40 is secured to the housing element 10. The housing element 10 has recesses 12. The recesses 12 are formed in particular as a passage. They also have an inner diameter smaller than the outer diameter of the connection means 50. The connection means 50 is formed in particular as a self-tapping screw having a self-tapping thread 44. The thread 44 of the self-tapping screw 44 creates its female thread itself by chipless shaping.

In accordance with a further embodiment the recesses in the housing element 10 have threads. These threads cooperate with the thread of the connection means 50, in particular of the screws.

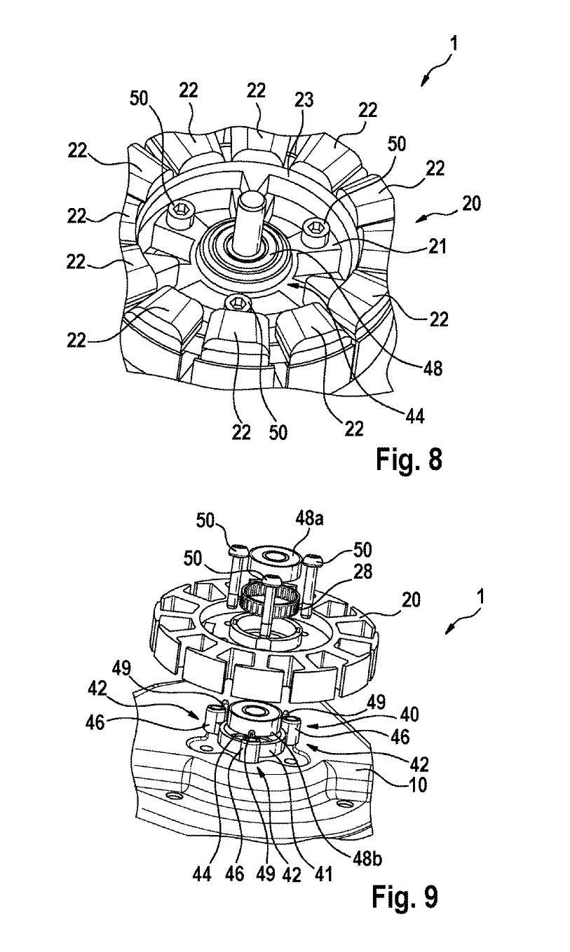

A partly assembled electric motor 1 is illustrated in FIG. 8. The electric motor 1 comprises a stator 20. The stator 20 comprises a stator core 21, which in particular is formed as a laminated core. The stator core 21 comprises stator teeth. The stator teeth comprise a stator tooth shaft and a stator tooth head. Stator coils 22 are wound around the stator tooth shafts. The stator core is advantageously overmolded by a thin plastic layer 23. The plastic layer 23 serves to protect the stator coils 22 and to mount the stator coils 22 on the stator core 21 in an improved way.

In accordance with FIG. 7 the carrier element 40 has a first recess 44, in which a bearing element 48 is arranged. The bearing element 48 supports or guides the rotor guide means 40 rotatably relative to the carrier means 40. The rotor (not shown) is connected to the rotor guide means 40 in a rotationally fixed manner. The rotor has at least one element, wherein the element consists for example of a ferromagnetic material, a magnetic material, or a material that has magnetic properties. The magnetic force generated by energizing the stator 20 acts on the elements of the rotor. A torque is produced as a result of the magnetic force and rotates the rotor. The elements of the rotor are arranged opposite the stator coils 22 in the radial direction. The rotor rotates about the stator 20. The electric motor 1 is formed as an external rotor motor in accordance with FIG. 8.

The connection means 50 are formed in particular as screws, advantageously as self-tapping screws. The connection means 50 connect the stator 20, the carrier means 40, and the housing element 10 to one another in a force-locked and/or form-locked manner.

FIG. 9 shows a further embodiment of an electric motor 1 according to the invention. The carrier means 40 has a first recess 44. The first recess 44 is arranged in the middle element 41 of the carrier means 40. A bearing element 48b is arranged inside the first recess 44. The carrier means 40 also has three spokes 42. The three spokes 42 each have a spoke rib 43 and a second recess 45. The second recess 45 is arranged in the spoke head 46. The spokes 42 and the middle element 41 are formed in one piece. The carrier means 40 is manufactured in particular as a sintered part.

A second bearing element 48b is arranged inside a recess 27 in the stator 20. A tolerance ring 28 is arranged between the stator 20 and the bearing element 48b. The tolerance ring enables the compensation of tolerances in the production of the stator 20 and the bearing element 48. The stator 20 and the bearing element 48 also have different coefficients of expansion. The different coefficients of expansion can also be compensated for by the tolerance ring 28.

The connection means 50, in particular screws, connect the stator 20, the carrier means 40 and the housing element 10. The connection means 50 enable the stator 20 and the carrier means 40 to be secured to the housing element 10.

In accordance with one embodiment the carrier means 40 comprises an orientation means 49. An orientation means 49 is arranged on each spoke head 46 in FIG. 9. The carrier means 40 thus has three orientation means 49. The three orientation means 49 engage in recesses in the stator 20 and orientate them relative to the carrier means 40. The stator 20 is thus oriented relative to the rotor guide means 25.

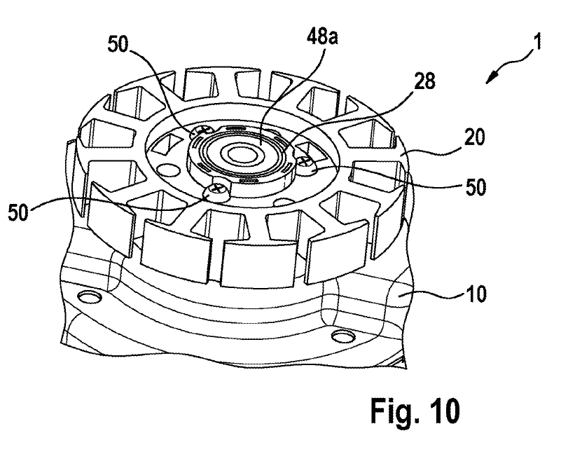

FIG. 10 shows the electric motor 1 described in FIG. 9 in the assembled state. The stator 20 is connected by means of the connection means, in particular the screws 50, to the carrier means 40 and the housing element 10 in a form-locked and force-locked manner, in particular in a rotationally fixed manner. The bearing element 48b is also arranged in the recess in the stator 20. The tolerance ring 28 is arranged between the bearing element 48a and the stator 20.

In accordance with a further exemplary embodiment the connection means 50 is embodied in the form of rivets or clips. In accordance with the invention, the connection of the carrier means 40 to the housing element 10 can also be implemented in particular by means of welding, soldering or adhesive bonding.

In accordance with a further exemplary embodiment the housing element 10 is part of an electric motor housing 5 surrounding the electric motor 1.

In accordance with a further embodiment the carrier means 40 is formed as a sheet metal part, in particular a deep-drawn sheet metal part, or as a diecast part, in particular made of zinc, aluminum or magnesium.

The connection means 50 advantageously has a seal, in particular a microencapsulation. The seal prevents an exchange of fluids between the region of the stator and the region of the housing element 10. A seal of this type is important in particular when the housing element 10 is part of a housing 5 that surrounds electronics.

In accordance with further embodiments the spokes 42 are arranged at an angle of from 30 to 180 degrees to one another. The angle is dependent on the number of spokes 42. The angles between the spokes 42 are advantageously substantially identical. The angle varies depending on the number of spokes 42, advantageously in steps/increments of 30 degrees. By way of example, the angle between the spokes 42 in the case of a carrier means 40 having four spokes 42 corresponds to 90 degrees, and in the case of a carrier means 40 having 12 spokes the angle corresponds to 30 degrees. A carrier means 40 having substantially identical angles between the spokes 42 has improved magnetic properties.

An electric motor 1 according to the invention can be embodied in particular as a brush motor, brushless motor, asynchronous motor, synchronous motor, electrically commutated motor, or as a stepper motor.

1. An electric motor (1), comprising a rotor guide means (25) and a housing element (10), characterized in that the housing element (10) is formed as a deep-drawn sheet metal part and a carrier means (40) is provided in order to mount the rotor guide means (25), wherein the carrier means (40) is arranged on the housing element (10).

2. The electric motor (1) as claimed in claim 1, characterized in that the carrier means (40) has a first recess (44), wherein the rotor guide means (25) is mounted in the first recess (44) in the carrier means (40) in a rotationally fixed or rotatable manner.

3. The electric motor (1) as claimed in claim 2, characterized in that the rotor guide means (25) and the carrier means (40) are connected.

4. The electric motor (1) as claimed in claim 2, characterized in that the carrier means (40) has a bearing element (48), and the bearing element (48) guides the rotor guide means (25) rotatably relative to the carrier means (40).

5. The electric motor (1) as claimed in claim 1, characterized in that the electric motor (1) comprises a stator (20) connected to the carrier means (40).

6. The electric motor (1) as claimed in claim 5, characterized in that the carrier means (40) comprises an orientation means (49), which orientates the stator (20) relative to the rotor guide means (25).

7. The electric motor (1) as claimed in claim 1, characterized in that the electric motor (1) comprises a connection means (50), wherein the connection means (50) connects the carrier means (40) to the housing element (10) and/or a stator (20) in a form-locked and/or force-locked manner.

8. The electric motor (1) as claimed in claim 7, characterized in that the connection means (50) is formed as a screw, and the carrier means (40) has a second recess (45), wherein the connection means (40) and the second recess (45) cooperate.

9. The electric motor (1) as claimed in claim 7, characterized in that the housing element (10) has a recess (12), wherein the recess (12) cooperates with the connection means (40).

10. The electric motor (1) as claimed in claim 1, characterized in that the carrier means (40) comprises a middle element (41) and at least one spoke (42), wherein the spoke (42) is arranged on the middle element (41) and the middle element (41) has a first recess (44).

11. The electric motor (1) as claimed in claim 10, characterized in that the spoke (42) has a second recess (45), for connection of the carrier means (40) to the housing element (10) and/or the stator (20), wherein the second recess (45) cooperates with a connection means (50).

12. The electric motor (1) as claimed in claim 1, characterized in that the electric motor (1) comprises control electronics, and the control electronics are arranged on the housing element (10).

13. The electric motor (1) as claimed in claim 1, wherein the electric motor is configured for a motor vehicle fan, and wherein the carrier means (40) is secured to the housing element (10) and is formed as a sintered part.

14. The electric motor (1) as claimed in claim 1, characterized in that the carrier means (40) has a first recess (44), which is continuous, wherein the rotor guide means (25) is mounted in the first recess (44) in the carrier means (40) in a rotationally fixed or rotatable manner.

15. The electric motor (1) as claimed in claim 14, characterized in that the rotor guide means (25) and the carrier means (40) are connected in a form-locked and/or force-locked manner, and the rotor guide means (25) is press fitted or cast in into the first recess (44) in the carrier means (40).

16. The electric motor (1) as claimed in claim 14, characterized in that the carrier means (40) has a bearing element (48) arranged in the first recess (44), and the bearing element (48) supports the rotor guide means (25) rotatably relative to the carrier means (40).

17. The electric motor (1) as claimed in claim 1, characterized in that the electric motor (1) comprises a stator (20), wherein the stator (20) is connected to the carrier means (40) in a form-locked and/or force-locked manner.

18. The electric motor (1) as claimed in claim 17, characterized in that the carrier means (40) comprises an orientation means (49), which centers the stator (20) relative to the rotor guide means (25).

19. The electric motor (1) as claimed in claim 1, characterized in that the electric motor (1) comprises a connection means (50), wherein the connection means (50) connects the carrier means (40) to the housing element (10) and/or a stator (20) in a form-locked and/or force-locked manner.

20. The electric motor (1) as claimed in claim 19, characterized in that the connection means (50) is formed as a self-tapping screw, and the carrier means (40) has a second recess (45), which is continuous, wherein the connection means (40) and the second recess (45) cooperate, the connection means (40) engaging in the second recess (45).

21. The electric motor (1) as claimed in claim 19, characterized in that the housing element (10) has a passage, wherein the recess (12) cooperates with the connection means (40).

22. The electric motor (1) as claimed in claim 1, characterized in that the carrier means (40) comprises a middle element (41) and at least one spoke (42), wherein the spoke (42) is arranged on the middle element (41) and the middle element (41) has a first recess (44).

23. The electric motor (1) as claimed in claim 22, characterized in that the spoke (42) has a second recess (45), which is continuous, for connection of the carrier means (40) to the housing element (10) and/or the stator (20), wherein the second recess (45) cooperates with a connection means (50).

24. The electric motor (1) as claimed in claim 1, characterized in that the electric motor (1) comprises control electronics, and the control electronics are arranged on the housing element (10), and the housing element (10) is part of the housing (5) of the control electronics.
